(19) United States
(12) Patent Application Publication
(10) Pub. No.: US 2023/0217951 A1
(43) Pub. Date: Jul. 13, 2023

(54) VARIEGATOR

(71) Applicant: Conopco, Inc., d/b/a UNILEVER, Englewood Cliffs, NJ (US)

(72) Inventors: Geoffrey Alec BURGESS, Wellingborough (GB); Gianfelice ROMANO, Zagarolo RM (IT); Georgios TETRADIS-MAIRIS, Bedford (GB); Giuseppe FERRANTE, Bedford (GB)

(73) Assignee: Conopco, Inc., d/b/a UNILEVER, Englewood Cliffs, NJ (US)

(21) Appl. No.: 16/470,751

(22) PCT Filed: Dec. 20, 2017
(86) PCT No.: PCT/EP2017/083902

§ 371 Date: Jun. 18, 2019

(30) Foreign Application Priority Data
Dec. 21, 2016 (EP) 16205925.7

(51) Int. Cl. A23G 9/22; A23G 9/16; A23G 9/28; A23G 9/48; B01F 25/4314

(52) U.S. Cl. CPC A23G 9/224; A23G 9/166; A23G 9/282; A23G 9/48; B01F 25/43141; B01F 2101/13

(57) ABSTRACT

A variegator and a process for using it. The variegator permits the manufacturer to obtain desirable patterns of distribution of sauce and chunks in frozen confections while at the same time permitting fast cleaning-in-place times to minimize factory downtime. The variegator comprises a) one or more conduits, each suitable for feeding a base frozen confection to a first opening or set of openings into a chamber, b) one or more conduits suitable for feeding a fluid variegating material such as a sauce through a second openings or set of openings at a level below the first set into the chamber below the base frozen confection opening, and c) a static mixer below the variegating material opening, the static mixer comprising at least two baffles.

### BACKGROUND OF THE INVENTION

Ice cream and other frozen desserts are among the most appreciated of treats. Although well-liked even without added components, the presence of inclusions such as sauces and chunks serves further to enhance the eating experience.

While consumers enjoy the presence of sauces and chunks in frozen desserts, individuals responsible for manufacturing the foods may feel some ambivalence given the challenges attendant to processing them. In particular, desirable chunk distribution and sauce swirl patterns may be difficult to achieve. This is a problem since it is believed desirable for consumers to experience the taste combination of ice cream, chunks and sauce in every spoonful of the product. Also, it is desirable to clean the equipment easily and quickly. Cleaning which takes too much time is an undesirable constraint on factory capacity.

Apparatuses called variegators are used to distribute sauces within a frozen dessert. There is a need for a variegator which promotes consistent distributions but which also permits quick cleaning.

CA687293 discloses a variegator having an opening for introduction of variegate below openings for introduction of ice cream. A rotor rotates to combine the variegate and the ice cream.

U.S. Pat. No. 3,408,960 discloses a variegator including a rotating spinner. For manufacturing a variegated frozen comestible, such as rippled ice cream, a suitable contrasting flavoring syrup is introduced into a T lateral for ultimate patterned introduction into the semi-frozen comestible, such as ice cream. The ice cream is introduced into a second T-fitting by means of a supply pipe carried by a lateral extension.

Moser U.S. Pat. No. 2,774,314 discloses a variegator and mentions that it has been proposed to interpose obstructing means in the path of a flowing matrix containing sauce streams so as to create turbulence which distributes the sauce. Distribution of sauces including solid particles such as fruits and nuts is mentioned.

Binley et al. US 2003/0068409 discloses a nozzle which may include a static mixer. The Binley et al. apparatus prepares frozen ice confections incorporating inclusions in such a way the flows comprising inclusions may be introduced discontinuously at a multiple positions. Binley et al.'s invention is said to be particularly applicable to preparation of frozen ice confections incorporating soft fruit pieces.

Peyton U.S. Pat. No. 2,669,946 discloses an apparatus employing dispersing discs for making variegated ice creams.

Watts GB 1,386,955 discloses a tube for promoting turbulence The tube may include turbulence promoting elements comprising helices.

Other devices are disclosed in Moser CA570098, Moser U.S. Pat. No. 2,979,996, Dutchess U.S. Pat. No. 3,014,437, GB 897820 (Plus Sales), Bell et al. U.S. Pat. No. 3,477,393, and Bell et al. CA883029.

### SUMMARY OF THE INVENTION

The present invention is directed to a variegator and to a process for using it. The variegator of the invention permits the manufacturer to obtain desirable patterns of distribution of sauce and chunks while at the same time permitting fast cleaning-in-place times to minimize factory downtime.

The variegator of the invention comprises a) one or more conduits, each suitable for feeding one or more base frozen confections to a first opening or set of openings into a chamber, b) one or more conduits suitable for feeding one or more fluid variegating materials such as a sauce or sauces through a second opening or set of openings at a level below the first set into the chamber below the base frozen confection opening(s), and c) a static mixer below the variegating material opening, the static mixer comprising at least two baffles.

Preferably, the first baffle of the static mixer is present directly below the opening of the variegating material into the chambers. In particular, the first baffle begins at from 0 to 12 mm from the bottom of the variegating material opening, preferably from 0.5 to 8 mm, especially 4-5 mm.

The variegator of the invention may include at least two conduits each suitable for feeding a base frozen confection to an opening in the chamber, the conduits each comprising at least one section feeding into an opening disposed along the same axis and being opposed to each other. The conduits may feed directly into the opening.

Advantageously, the axis of the conduit suitable for feeding the one or more variegating materials through the one or more second openings into the chamber is disposed perpendicularly to at least one of the one or more conduits suitable for feeding the one or more base frozen confections to the opening into the chamber. Preferably, the axes of all variegating material conduits at the points they enter the chambers to combine with the one or more base frozen confections are perpendicular to the axes of all frozen confection conduits, at the points they enter the chamber(s).

The baffles of the static mixer will generally be helical.

Preferably, the static mixer has two vertically extending sides and there are at least two conduits suitable for feeding one or more variegating materials through at least two second openings into the chambers at points below the ice cream or other frozen confection opening(s). The static mixer first section is on a first side of the static mixer and is situated to receive the variegating material from the first variegating material conduit, and a second static mixer section on a second side of the static mixer receives the variegating material from the second conduit.

The fluid variegating material may be a single fluid material such as a sauce, a mix of fluid materials (e.g., sauces or different sauces), each introduced into one or two or more openings into the chambers at points below the ice cream (or other frozen confection) opening(s). That is, the variegating material introduced into one opening into the chamber can be the same or different from the variegating material introduced through another opening or openings.

The invention is also directed to a process for preparing a frozen confection using the variegator of the invention. The invention may comprise: feeding one or more base frozen confections through one or more conduits to a first opening or set of openings into a chamber, feeding one or more fluid variegating materials through one or more conduits through a second opening or set of openings below the first opening set into the chamber below the base frozen confection opening(s), and feeding the combined frozen base confection and variegating material into a static mixer below the variegating material opening(s), the static mixer comprising at least two baffles.

In the process of the invention, the first baffle of the static mixer is preferably in close proximity to the bottom of the opening(s) of the variegating one or more variegating materials into the chamber. As indicated above, preferably, the first of the at least two static mixer baffles begins at from 0 to 12 mm from the bottom of the variegating material opening, preferably from 0.5 to 8 mm, especially 4-5 mm.

The process of the invention preferably comprises feeding the one or more base frozen confections through at least two said conduits, each to an opening in the chamber, the conduits comprising at least one section disposed along the same axis and opposed to each other. Preferably, the axis of the conduit through which the variegating material is fed through the one or more second openings into the chambers is disposed perpendicularly at the point of entry to the chamber(s) to the axis of at least one of the one or more conduits through which the base frozen confection is fed to the base frozen confection opening into the chambers at the point of entry to the chamber(s). More preferably, the axes of all base frozen confection conduits at the points they enter the chamber(s) are perpendicular to the axes of all variegating material conduits at the points they enter the chambers.

The baffles of the static mixer will typically be helical.

The process preferably includes feeding the one or more variegating material through the second set of openings into the chamber through at least two conduits to the static mixer wherein the static mixer comprises a first section on a first side of the static mixer for receiving the one or more variegating material from one of the variegating material conduits and a second section on a second side of the static mixer for receiving the same or different one or more variegating material from the second of the variegating material conduits.

In accordance with the process of the invention, particulate inclusions are contained in the base frozen confection as it is fed into the variegator. The particulate inclusions may be chunks having an average length of from 0.5 to 30 mm and an average volume of from 0.125 to 27000 mm3. Exemplary lengths for runs of several products areas follows:

| | mm | mm | mm | mm\hat{ }3 |
|---|---|---|---|---|
| Chunk Size min (mincup) | 0.5 | 0.5 | 0.5 | 0.125 |
| Chunk Size max (mincup) | 20 | 20 | 20 | 8000 |
| Chunk Size min (pint) | 0.5 | 0.5 | 0.5 | 0.125 |
| Chunk Size max (pint) | 30 | 30 | 30 | 27000 |

Particulate inclusions may be included in the base frozen confection at a level of 0% to 60% especially 10% to 50% with the weight percent of particulate inclusions based on the weight of the frozen confection (including inclusions as introduced into the variegator, but excluding the variegating material). Example of particulate inclusions comprise chunks of chocolate, cookie dough, cookie. etc. More broadly, inclusions present in the frozen confection when introduced into the variegator may include oil based chunks/inclusions, thick pastes, baked inclusions and nuts.

By base frozen confection herein is meant the frozen confection minus the fluid variegating material such as sauce. Since particulate inclusions will be fed as part of the base frozen confection, base frozen confection may include any particulate inclusions.

For a more complete understanding of the above and other features and advantages of the invention, reference should be made to the following description of the preferred embodiment.

### BRIEF DESCRIPTION OF THE DRAWINGS

FIG. 1 is a perspective view from the front and above of the variegator of the invention.

FIG. 2 is a cross section along the lines II-II of FIG. 1 viewed from the rear of FIG. 1.

FIG. 3 is a cross section along the lines III-III of FIG. 1 viewed from the right side of FIG. 1.

FIG. 4 comprises photographs of products produced using the variegator of the Invention.

### DETAILED DESCRIPTION OF THE INVENTION

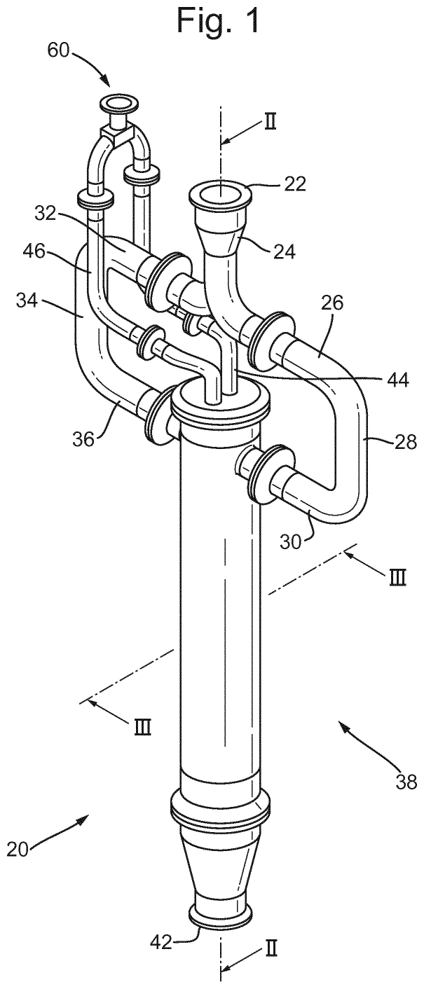

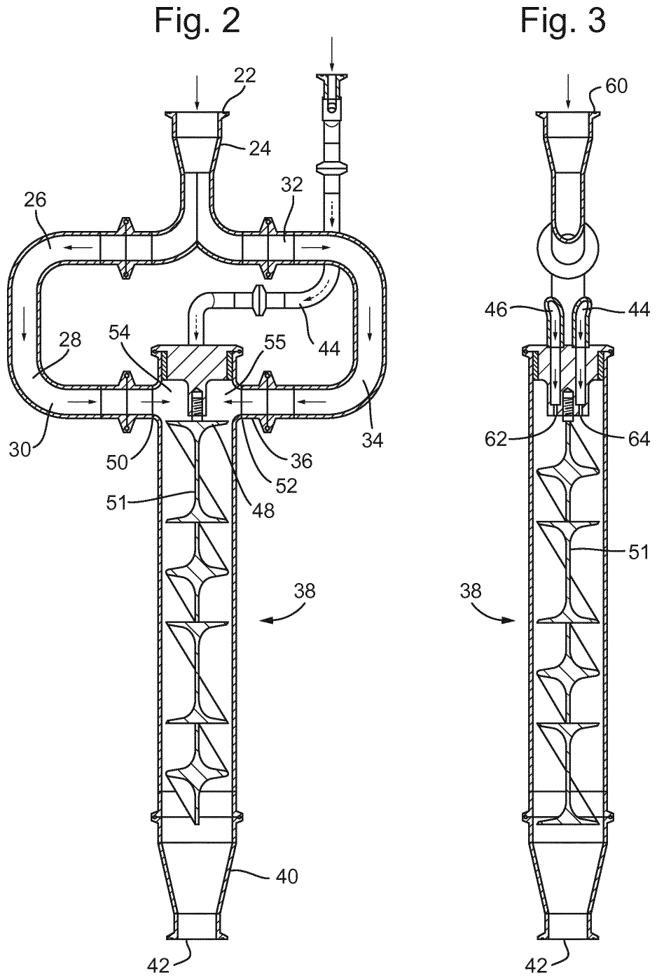

Variegator 20 (FIG. 1) comprises base frozen confection feeding opening 22 and downwardly extending common conduit 24. Base frozen confection may be fed into opening 22 from a freezer. Conduit 24 divides into two horizontally extending frozen confection conduits 26 and 32. Conduit 26 leads to downwardly extending conduit 28 whereas conduit 32 leads to downwardly extending conduit 34. After travelling through conduits 28, 34, base frozen confection enters horizontally extending conduits 30, 36 which are oriented along the same horizontal axis and are opposed, i.e., they lead toward each other. Conduits 30, 36 lead to openings 50, 52 (FIG. 2) into chambers 54, 55 (FIG. 2).

Although illustrated in FIGS. 1 and 2 as having a single base frozen confection opening 22, more than one opening could be provided, particularly if it desired to introduce different base frozen confections into chambers such as 54, 55.

Opening 60 (FIG. 1) receives sauce or other fluid (sauce can be in temperature range of −10° C. to 40° C., preferably −5 to 20° C.) variegating materials and divides into two conduits 46, 44. Conduits 46, 44 lead to openings 62, 64 (FIG. 3) into chambers 54 and 55, respectively (FIG. 2). Variegating material openings 62, 64 (FIGS. 3, 6) are below base frozen confection openings 50, 52.

Although illustrated in FIGS. 1 and 3 as having a single fluid variegating material opening 60, more than one opening could be provided, particularly if it desired to introduce different fluid variegating materials into chambers such as 54, 55.

Chambers 54, 55 lead into static mixer 38. A short distance below openings 62,64 is first static mixer baffle 48. Static mixer 38 includes a series of helical baffles starting with baffle 48. Effectively the baffles divide the first and second sides of the static mixer into separate sections. Base frozen confection and variegating material are mixed in each of the first and second sides of the static mixer as they descend through the mixer and encounter the static baffles. Using the separate sections the static mixer divides and recombines the mix and gives a “rainbow” effect.

After passing through all of the baffles, the mixed frozen confection encounters tapered funnel section 40 and variegator exit opening 42.

In operation, base frozen confection, such as ice cream, emerging from a freezer is fed into opening 22 and then common conduit 24. One or more pumps or freezers or Scape Heat Exchangers may be used to urge the base frozen confection and variegating material through variegator 20. The base frozen confection than traverses horizontal conduits 26, 32, travels downwardly though conduits 28, 34 and horizontally back toward the center of the variegator via opposed collinear conduits 30, 36. The base frozen confection (or confections) travel(s) through openings 50, 52 into chambers 54, 55.

Variegating material, which will typically be a sauce, is at the same time fed into opening 60, through conduits 46, 44, and through openings 62, 64, which are below frozen confection openings 50, 52, and into chambers 54, 55 and perpendicular to the directions from which base frozen confection enters the chambers through conduits 30, 36.

It has been found that good results are obtained if the base frozen confection and variegating material such as sauce are pumped such that after entering chambers 54, 55 they move downward at the same speed. That is, preferably the base frozen confection does not drive the flow of sauce or other variegating material.

Shortly thereafter, the base frozen confection and variegating material encounter a series of helical baffles of static mixer 38. Preferably, each helical buffle is 90 deg offset from the next one. The helical baffles effectively divide the mixer into two sides. Static mixers are motionless mixers which derive the fluid motion or energy dissipation needed for mixing from the flowing fluid itself. They comprise repeated structures referred to as mixing elements or baffles attached inside a pipe. The mixing elements divide and recombine fluids which pass there through.

The variegator of the invention may include various types of dosing dispensing devices.

The base frozen confection (prior to combining with the fluid variegating material) is preferably aerated, i.e., it has an overrun of more than 20 percent, preferably more than 30 percent, more preferably more than 50 percent. Preferably, the base frozen confection has an overrun of less than 200 percent, more preferably less than 150 percent, most preferably less than 120 percent. Overrun is defined by the equation below and is measured at atmospheric pressure:

Overrun %=((density of mix−density of frozen confection)/density of frozen confection)×100

The base frozen confection is a frozen product, such as ice cream, sherbet, water ice, milk ice, frozen yoghurt and the Ike. Non dairy “ice creams” such as those using vegetable fat instead of milk fat may be used. “Frozen,” as used herein, denotes that the product is solidified under freezing conditions to a hardpack or pumpable consistency. The ice content of the frozen confection should be more than 15% but less than 45%. The frozen confection flavored with the sauce or other fluid variegating material may be combined with other ingredients such as wafers in an ice cream sandwich.

The frozen confection is preferably a water-continuous emulsion. More than one base frozen confection may be used, if desired. For instance, two different base frozen confections can be mixed together before introduction into the variegator, or different base frozen confections can be introduced through each opening.

The sauce or other fluid variegating materials are non-solids. They are preferably soft enough at their processing temperatures (−10° C. to 40° C., preferably −5 to 20° C.), generally semi-solid or liquid, to be pumped (from Freezer or scrape heat exchanger) to the static mixer and, after mixing in the static mixer, form a frozen confection which is non-homogeneous to taste and to the eye e.g., present as a ripple. One of ordinary skill can ascertain whether the flavorant/ingredient is sufficiently non-solid. Examples of fluid variegating agents include nut pastes such as peanut butter, almond butter, fudge, other chocolate sauce, caramel etc. The one or more fluid variegating materials can even be a frozen confection such as ice cream so long as it is sufficiently fluid to travel through the fluid variegating material orifice leading into the variegator.

The sauce or other fluid variegating materials are preferably present in the base frozen confection at levels of from 2.5 to 50 wt. %, especially from 5-30 wt. %, the wt % calculation excluding the weight of any solid inclusions such as chunks. The base frozen confection, excluding any solid inclusions, is preferably present at from 97.5 to 70 wt. %, especially from 80 to 96 wt. %.

Generally, the product of the invention will include a dairy source, such as whole milk, skim milk, condensed milk, evaporated milk, cream, butter, butterfat, whey, milk solids non-fat, etc. The dairy source will generally contribute dairy fat and/or non-fat milk solids such as lactose and milk proteins, e.g. whey proteins and caseins. A dairy protein powder, such as whey protein, may be used as a protein source. Lactose will generally be present in the base frozen confections used in the invention within the range of from 0 to 8 wt. %, especially from 0.5 to 7%, more preferably from 3 to 8 wt. % (i.e., excluding the fluid variegating material) and excluding solid inclusions—that is, the ice cream or the like to which the sauce or other fluid flavoring is added minus any solid inclusions). Dairy proteins will generally be present in the base frozen confections of the invention at from 1 to 5 wt. %, especially from 1 to 3 wt. % (i.e., excluding sauce or other fluid variegating material) and excluding solid inclusions). Other proteins may be present at from 0 to 3 wt. %.

While butter fat from cream and other dairy sources is preferred in the base frozen confection, alternative fat sources, such as vegetable fat, may be used in some embodiments of the invention. For example, fats may be taken from the group which includes cocoa butter, illipe, shea, palm, palm kernal, sal, soybean, cottonseed, coconut, rapeseed, canola, and sunflower oils and mixture thereof.

The level of triglyceride fat in the base frozen confection product, (i.e., excluding sauce or other fluid variegating material) and excluding solid inclusions), indeed preferably the total level of digestible lipid in the base frozen confection product, is preferably from 2 wt. % to 20 wt. %, more preferably, from 3 wt. % to 15 wt. %.

If desired, the product may include an emulsifying agent. Typical emulsifying agents may be phospholipids and proteins, such as dairy or soy proteins, or esters of long chain fatty acids and a polyhydric alcohol. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Mono- and di-glycerides may also be used but may also be omitted. Indeed, emulsifiers other than proteins and phospholipids may be omitted. If present, non-protein emulsifiers are used in amounts of about 0.03 percent to 0.5 percent, preferably 0.1 percent to 0.3 percent by weight of the base frozen confection, (i.e. excluding the sauce or other fluid variegating agent) and excluding any solid inclusions.

Gum stabilizers are particularly effective in controlling viscosity, providing mouth feel and improving whipping (aerating) properties; to provide a protective colloid to stabilize proteins to heat processing; to modify the surface chemistry of fat surfaces to minimize creaming; to provide acid stability to protein systems and; to increase freeze-thaw stability. Gums can be classified as neutral and acidic, straight- and branched-chain, gelling and non-gelling. The principal gums that may be used are Karaya gums, locust bean gum, carageenan, xanthan, guar, alginate and carboxymethyl cellulose.

Gums are generally used in concentrations of 0.02-0.5 wt. % of the base frozen confection composition (i.e. excluding the sauce or other fluid variegating agent) and excluding any solid inclusions. Because of differing functionalities, combinations of certain gums may provide a better product than a single gum. For instance, for some types of frozen confections karaya gum is ideally used together with polydextrose.

The stabilizer may be microcrystalline cellulose as described in U.S. Pat. No. 5,209,942, e.g., Avicel 581, which is activated or “peptized.” A combination of microcrystalline cellulose and sodium carboxymethyl cellulose (CMC) may give good results.

Microcrystalline cellulose has been listed in the Fourth Supplement to the Food Chemicals Codex, First Edition, by the National Academy of Sciences-National research Council as: Cellulose, Microcrystalline (cellulose gel). Cellulose gel in combination with cellulose gum is especially preferred.

Another component may comprise one or any combination of carboxymethylcellulose (in addition to that with which the microcrystalline cellulose may be coated), xanthan gum, starch and alginate.

If desired, gelatin, e.g., 225 bloom, may be included in the base frozen confection compositions at levels of say 0.1-1 wt. %, especially from 0.1-0.3 wt. % (i.e. excluding the sauce or other fluid variegating agent) and excluding any solid inclusions. Certain salts such as phosphates and chlorides may be employed to alter the buffering capacity of the system and to improve the water binding capacity of proteins and improve solubility and flavor. Sodium chloride and sodium monophosphate at very low levels are preferred but calcium phosphate and particularly monocalcium phosphate may also be employed. Sodium chloride is preferred at levels of 0.05 percent to 0.3 percent of the base frozen confection; and sodium monophosphate is preferred at levels of 0.01 percent to 0.1 percent of the base frozen confection (i.e. excluding the sauce or other fluid variegating agent) and excluding any solid inclusions

Generally, the compositions of the invention will be naturally sweetened. Natural sources of sweetness include sucrose (liquid or solids), glucose, fructose, and corn syrup (liquid or solids). Other sweeteners include lactose, maltose, and galactose. Levels of sugars and sugar sources preferably result in sugar solids levels of up to 28 wt. % in the base frozen confection, preferably from 5 to 24 wt. %, especially from 10 to 24 wt. %.

If it is desired to use artificial sweeteners, any of the artificial sweeteners well known in the art may be used, such as aspartame, saccharine, Alitame (obtainable from Pfizer), acesulfame K (obtainable from Hoechst), cyclamates, neotame, sucralose and the like, and mixtures thereof. The sweeteners are used in varying amounts of about 0.005 percent to 1 percent of the base frozen confection, preferably 0.007 percent to 0.73 percent depending on the sweetener, for example. Aspartame may be used at a level of 0.01 percent to 0.15 percent of the base frozen confection, preferably at a level of 0.01 percent to 0.05 percent. Acesulfame K is preferred at a level of 0.01 percent to 0.15 percent of the base frozen confection. Above artificial sweetners are percentages of the base frozen confection (i.e. excluding the sauce or other fluid variegating agent) and also excluding any solid inclusions.

Natural low- or non-caloric sweeteners such as stevia may be used at levels of from 0.01 to 0.15, especially 0.01 to 0.05 of the base frozen confection (i.e. excluding the sauce or other fluid variegating agent) and excluding any solid inclusions.

If desired, the product may include polydextrose. Polydextrose functions both as a bulking agent and as a fiber source and is preferably included at from 1 to 10 wt. %, especially from 3 to 6 wt. % of the base frozen confection (i.e. excluding the sauce or other fluid variegating agent) and excluding any solid inclusions.

Polydextrose may be obtained under the brand name Litesse from Danisco Sweeteners. Among other fiber sources which may be included in the compositions of the invention are fructose oligosaccharides such as inulin. Additional bulking agents which may be used include maltodextrin, sugar alcohols, corn syrup solids, sugars or starches. Total bulking agent levels in the base frozen confections of the invention will may be from about 5 percent to 20 percent, preferably 13 percent to 16 percent (i.e. excluding the sauce or other fluid variegating agent) and excluding any solid inclusions.

If desired, sugar alcohols such as glycerol. sorbitol, lactitol, maltitol, mannitol, etc. may be used to control ice formation. If present, sugar alcohols may be used in an amount of about 1 percent to 8 percent, preferably 2.5 percent to 8.0 percent of the base frozen confection (i.e. excluding the sauce or other fluid variegating agent) and excluding any solid inclusions. However, the present invention also contemplates formulations in which glycerol is excluded.

In addition to the sauce or other fluid variegating materials, other flavorings are preferably added to the product but preferably in amounts that will impart a mild, pleasant flavor. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of the basic flavors. The confection compositions are flavored to taste as mentioned above. Suitable flavorants may also include seasoning, such as salt, and imitation fruit or chocolate flavors either singly or in any suitable combination.

Malt powder can be used, e.g., to impart flavor, preferably at levels of from 0.01 to 3.0 wt. % of the base frozen confection, especially from 0.05 to 1 percent (i.e. excluding the sauce or other fluid variegating agent) and excluding any solid inclusions.

Preservatives such as potassium sorbate may be used as desired.

Adjuncts such as wafers and coatings may be included as desired. In the case of, coatings, they are typically present at from 5 to 30 wt. % of the base frozen confection of the invention (including the weight of the coating but excluding the weight of the sauce or other fluid variegating agent and excluding the weight of any solid inclusions.)

Water/moisture/ice will generally constitute the balance of the base frozen confection at, e.g., from 40-90 wt. %, especially from 50-75 wt. % (i.e. excluding the sauce or other fluid variegating agent) and excluding any solid inclusions.

Apart from the use of the variegator, processes used for manufacture of the products are similar to those used for conventional frozen confections. Typical process steps include: ingredient blending, pumping, pasteurization, homogenization, cooking, aeration, freezing and packaging. In accordance with the invention, after freezing and before packaging, the frozen confection is combined with the fluid variegating material in, and just before, the static mixer to form the frozen confection of the invention.

Products can be manufactured by batch or by continuous processes, preferably continuous. Ingredients may be either liquid or dry, or a combination of both. Liquid ingredients can be blended by the use of positive metering pumps to a mixing tank or by in-line blending.

Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of any fat and sufficient to fully hydrate any gums used as stabilizers and any proteins.

Pasteurization is generally carried out in high temperature short time (HTST) units, in which the homogenizer is integrated into the pasteurization system. Protein and any microcrystalline cellulose are advisedly fully hydrated before adding other components which might interfere with the hydration.

Use of the variegator and process of the invention results in consistent patterns of distribution of sauce and chunks in frozen confections such as ice cream while at the same 5 time permitting fast cleaning-in-place times to minimize factory downtime.

### EXAMPLE

A Ben & Jerry's brand premium ice cream with chocolate cookie pieces and dark caramel swirl is processed using the equipment and process described above and shown in FIGS. 1-3. The chocolate cookie pieces are included in the base ice cream using an inline dispenser device after the freezer and fed into the base frozen confection opening of the variegator, and the caramel swirl is introduced as the fluid variegating material.

After being fed through the variegator, the ice cream is packed and the variegator is then cleaned in place. Six trials are done and the tests shown in Table 1 are performed to measure the success of the cleaning. The quality of ice cream produced in six trials is measured and the results are provided in Table 2. The cleaning in place procedure is set forth in Table 3.

TABLE 1

| | RESULT | | | | | |
|---|---|---|---|---|---|---|
| CHECK | A | B | C | D | E | F |
| VISUAL INSPECTION | | | | | | |
| (PASS-FAIL) | | | | | | |
| Contamination will not | PASS | PASS | PASS | PASS | PASS | PASS |
| be visible with the surface | | | | | | |
| wet or dry | | | | | | |
| The surface will not give | PASS | PASS | PASS | PASS | PASS | PASS |
| a greasy feeling to clean | | | | | | |
| fingers when they are | | | | | | |
| rubbed onto the surface | | | | | | |
| No objectionable odour | PASS | PASS | PASS | PASS | PASS | PASS |
| will be apparent | | | | | | |
| A new, white facial tissue | PASS | PASS | PASS | PASS | PASS | PASS |
| wiped several times over | | | | | | |
| the surface will show no | | | | | | |
| discoloration | | | | | | |
| The surface is completely | PASS | PASS | PASS | PASS | PASS | PASS |
| wetted when water is | | | | | | |
| draining from it | | | | | | |
| ATP MEASUREMENTS | 0 | 0 | 0 | 19 | 0 | 1 |
| (PASS if less of 30) | | | | | | |
| RESIDUAL PROTEIN | PASS | PASS | PASS | PASS | PASS | PASS |
| DETECTION | | | | | | |
| (PASS-FAIL) | | | | | | |

As can be seen in Table 1. all tests are passed after cleaning in place.

TABLE 2
Knife Value

| | QUALITY CHECK RESULTS | | | | | |
|---|---|---|---|---|---|---|
| | Trial A | | | Trial B | | |
| | SET | SET | SET | SET | SET | SET |
| | 1 | 2 | 3 | 1 | 2 | 3 |
| Colour [PASS/OKAY/ | | | | | | |
| FAIL] | | | | | | |
| Ice cream is off white | PASS | PASS | PASS | PASS | PASS | PASS |
| Chocolate covered waffle | PASS | PASS | PASS | PASS | PASS | PASS |
| cone pieces are dark brown | | | | | | |
| Caramel variegate is light | PASS | PASS | PASS | PASS | PASS | PASS |
| brown to medium brown | | | | | | |
| with an approximate ¼″ | | | | | | |
| vein throughout the pint | | | | | | |
| Texture [PASS/OKAY/ | | | | | | |
| FAIL] | | | | | | |
| Ice cream is smooth and | PASS | PASS | PASS | PASS | PASS | PASS |
| creamy | | | | | | |
| Crisp Waffle Cone pieces | PASS | PASS | PASS | PASS | PASS | PASS |
| Smooth caramel variegate | PASS | PASS | PASS | PASS | PASS | PASS |

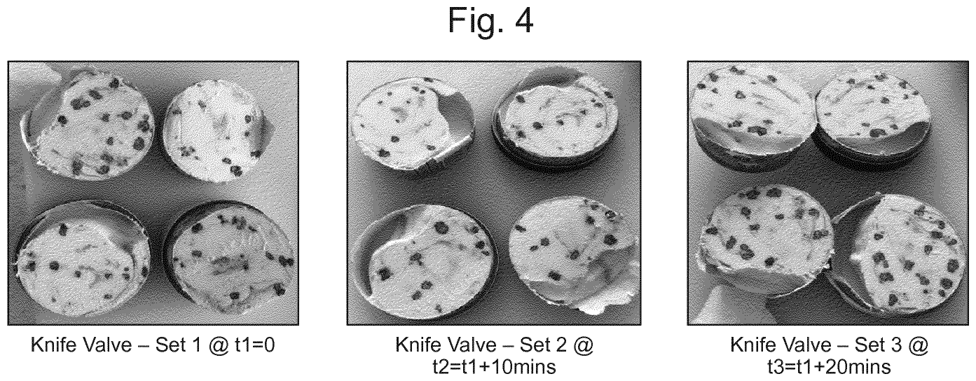

As seen in Table 2. all quality criteria are passed using the variegator and process of the invention.
Samples of products made in accordance with the invention are shown in FIG. 4. The chunks. the cookie dough pieces and the swirls are evenly distributed.

1. A variegator comprising:
a. one or more conduits each suitable for feeding one or more base frozen confections to a first set of one or more openings into a chamber,
b. one or more conduits suitable for feeding one or more fluid variegating materials through a second set of one or more openings into the chamber, the second set of one or more openings being at a level below the first set of one or more base frozen confection openings, and
c. a static mixer below the one or more variegating material openings, said static mixer comprising at least two baffles, the axis of the conduit through which the variegating material is fed through the one or more second openings into the chambers is disposed perpendicularly at the point of entry to the chamber(s) to the axis of at least one of the one or more conduits through which the base frozen confection is fed to the base frozen confection opening into the chambers at the point of entry to the chamber(s).

2. The variegator according to claim 1 wherein a first of the at least two static mixer baffles begins at from 0 to 12 mm of the bottom of the variegating material opening or openings.

3. The variegator according to claim 1 comprising at least two said conduits each suitable for feeding a base frozen confection to an opening in the chamber, the conduits comprising at least one section disposed along the same axis and opposed to each other and feeding into the opening.

4. The variegator according to claim 1 wherein the axes of all variegating material conduits at the points they enter the chambers to combine with the one or more base frozen confections are perpendicular to the axes of all frozen confection conduits, at the points they enter the chamber(s).

5. The variegator according to claim 1 wherein the baffles of the static mixer are helical.

6. The variegator according to claim 1 comprising at least two conduits suitable for feeding the one or more fluid variegating materials through at least two second openings into the chamber below the ice cream opening or openings, the static mixer comprising a first section on a first side of the static mixer for receiving the variegating material from the variegating material conduit and a second section on a second side of the static mixer for receiving the variegating material from the second conduit.

7. A process for preparing a frozen confection comprising:
a. feeding one or more base frozen confections through one or more conduits to a first opening or set of openings into a chamber,
b. feeding one or more fluid variegating materials through one or more conduits through a second opening or set of openings into the chamber below all base frozen confection opening or openings, and
c. feeding the combined frozen base confection and fluid variegating material into a static mixer below the variegating material opening or openings, said static mixer comprising at least two baffles, the axis of the conduit through which the variegating material is fed through the one or more second openings into the chambers is disposed perpendicularly at the point of entry to the chamber(s) to the axis of at least one of the one or more conduits through which the base frozen confection is fed to the base frozen confection opening into the chambers at the point of entry to the chamber(s).

8. The process according to claim 7 wherein a first of the at least two static mixer baffles begins a from 0 to 12 mm of the bottom of all of the variegating material opening or openings.

9. The process according to claim 7 comprising feeding the one or more base frozen confections through at least two said conduits, each to an opening in the chamber, the conduits comprising at least one section disposed along the same axis and opposed to each other and feeding directly into the openings.

10. The process according to claim 7 wherein the axes of all variegating material conduits at the points they enter the chambers to combine with the one or more base frozen confections are perpendicular to the axes of all frozen confection conduits, at the points they enter the chamber(s.

11. The process according to claim 7 wherein the baffles of the static mixer are helical.

12. The process according to claim 7 comprising feeding the one or more fluid variegating materials through at least two openings into the chamber through at least two conduits to the static mixer wherein the static mixer comprises a first section on a first side of the static mixer for receiving the one or more variegating materials from one of the variegating material conduits and a second section on a second side of the static mixer for receiving the variegating material from the second of the variegating material conduits.

13. The process according to claim 7 wherein particulate inclusions are included in the base frozen confection as it is fed into the variegator.

14. The process according to claim 13 wherein the particulate inclusions are chunks having an average length of from 0.5 to 30 mm and an average volume of from 0.125 to 27000 mm3.
